(19) United States
(12) Patent Application Publication
(10) Pub. No.: US 2025/0050632 A1
(43) Pub. Date: Feb. 13, 2025

(54) Intermediate Transfer Member

(71) Applicant: Landa Corporation Ltd., Rehovot (IL)

(72) Inventors: Benzion Landa, Nes Ziona (IL); Helena Chechik, Rehovot (IL); Ifaa Terem Kolodkin, Nes Ziona (IL)

(21) Appl. No.: 18/719,273

(22) PCT Filed: Dec. 29, 2022
(86) PCT No.: PCT/IB2022/062883

§ 371 Date: Jun. 13, 2024

Related U.S. Application Data
(60) Provisional application No. 63/296,173, filed on Jan. 4, 2022.

(51) Int. Cl. B41J 2/005; B32B 5/02; B32B 7/022; B32B 27/12; B41J 2/01

(52) U.S. Cl. CPC B41J 2/0057; B32B 5/024; B32B 7/022; B32B 27/12; B32B 2260/021; B32B 2260/046; B32B 2262/101; B32B 2264/108; B32B 2307/202; B32B 2307/54; B32B 2307/75; B41J 2002/012

(57) ABSTRACT

An intermediate transfer member (ITM) (44) of printing system (10), the ITM includes: (a) an outer layer (102) configured to receive droplets (11) of printing fluid for producing an image thereon, and transfer the image to target substrate (50), and (b) a stack (107) of flexible support layers, the stack includes a mesh (109), having a first section impregnated in a first layer (106) having a first elastic modulus in an axis in which a tension force is applied to the ITM (44), and a second section impregnated in a second layer (108), which is placed in contact with the first layer (106) and has in the axis, a second elastic modulus different from the first clastic modulus. In response to applying to the ITM (44) a specified level of the tension force, the stack (107) is configured to retain a predefined elongation of the ITM (44) along the axis.

### CROSS-REFERENCE TO RELATED APPLICATIONS

This application claims the benefit of U.S. Provisional Patent Application 63/296,173, filed Jan. 4, 2022, whose disclosure is incorporated herein by reference.

### FIELD OF THE INVENTION

The present invention relates generally to digital printing, and particularly to methods and systems for improving rigidity and electrical conductivity of an intermediate transfer member.

### BACKGROUND OF THE INVENTION

Various techniques for improving the rigidity and electrical conductivity of intermediate member used in printing system have been published.

For example, U.S. Pat. No. 6,753,050 describes an image transfer sheet that includes an image imparting layer and an adhesive layer. The adhesive layer permits transfer of an image to a substrate.

U.S. Pat. No. 9,180,659 describes an aqueous transfix blanket and a printer including the aqueous transfix blanket. The aqueous transfix blanket includes a screen layer including a plurality of mesh wires that define a plurality of spaces between the plurality of mesh wires. The aqueous transfix blanket further includes a first layer that overlies the screen layer and a second layer that underlies the screen layer, wherein the plurality of spaces provide a plurality of air gaps between the first layer overlying the screen layer and the second layer underlying the screen layer.

U.S. Pat. No. 10,606,191 describes a layered article that can be used in indirect printing, in analog or digital processes. The layered article, when configured as a transfer member, may serve to receive an ink in any form, allow the ink to be treated so as to form an ink image, and permit the application of the ink image on a substrate. The transfer member comprises a support layer and an imaging layer, which may be formed of a silicon matrix including dispersed carbon black particles. Methods for preparing the same are also disclosed.

U.S. Patent Application Publication 2015/0210065 describes a transfer member or blanket for use in aqueous ink jet printer. The transfer member includes a surface layer that includes an elastomeric matrix having copper particles and carbon nanotubes dispersed therein. The weight percent of the copper particles in the surface layer is from about 1 weight percent to about 30 percent. The weight percent of the carbon nanotubes is from about 1 weight percent to about 10 weight percent.

### SUMMARY OF THE INVENTION

An embodiment of the present invention that is described herein provides an intermediate transfer member (ITM) of a printing system, the ITM includes: (a) an outer layer, which is configured to receive droplets of a printing fluid for producing an image thereon, and to transfer the image to a target substrate, and (b) a stack of flexible support layers, the stack includes a mesh, having: (i) a first section impregnated in a first layer having a first elastic modulus in an axis in which a tension force is applied to the ITM, and (ii) a second section impregnated in a second layer, which is placed in contact with the first layer and has in the axis, a second elastic modulus different from the first elastic modulus. In response to applying to the ITM a specified level of the tension force, the stack of flexible support layers is configured to retain a predefined elongation of the ITM along the axis.

In some embodiments, the mesh includes a woven fiberglass fabric. In other embodiments, the second layer includes a substance selected from a list of substances consisting of: (i) epoxy, (ii) Poly Aryl Ether Ketone (PAEK), (iii) Polysaccharides, (iv) polyimide. Polyethylene Terephthalate, and (v) a combination of two or more of the substances of the list. In yet other embodiments, the ITM includes an additional outer layer, which is configured to be placed in contact with an ITM module, the ITM module is configured for moving the ITM along the axis, the additional outer layer including: (i) a flexible substrate, configured to conform with one or more components of the ITM module and to have a friction with at least one of the one or more components for moving the ITM along the axis, and (ii) one or more electrically conductive additives.

In an embodiment, the one or more electrically conductive additives are configured to discharge an electrostatic charge away from the flexible substrate. In another embodiment, the electrically conductive additives include one or more additives selected from a list of additives consisting of: (i) one or more nanotubes (NTs), (ii) one or more particles, and (iii) a combination of the one or more NTs and particles. In yet another embodiment, the NTs include carbon nanotube (CNTs) selected from a list of CNTs consisting of: (i) a multi-wall CNT (MWCNT), (II) a single-wall CNT (SWCNT), and (iii) a combination of one or more MWCNTs and MWCNTs.

In some embodiments, the additional outer layer includes one of: (i) a first volume concentration of the MWCNT, (ii) a second volume concentration of the SWCNT, which is smaller than the first volume concentration, and (iii) a combination of the MWCNT and SWCNT having a third volume concentration that is smaller than the first volume concentration and larger than the second volume concentration, so as to obtain a predefined electrical conductivity of the additional outer layer. In other embodiments, the CNTs are configured to alter one or both of: (i) a third clastic modulus of the additional outer layer, and (ii) a thermal conductivity of the additional outer layer. In yet other embodiments, the one or more particles are selected from a list of particles consisting of: (i) metallic nanoparticle (NPs), (ii) carbon-based NPs, (iii) glass particles coated with metal, (iv) graphene particles, (v) graphite particles, and (vi) a combination of two or more of the particles selected from the list of particles.

There is additionally provided, in accordance with an embodiment of the present invention, a method for producing an intermediate transfer member (ITM) of a printing system, the method including producing an outer layer for: (i) receiving droplets of a printing fluid and producing an image thereon, and (ii) transferring the image to a target substrate. A stack of flexible support layers is produced by impregnating (i) a first section of a mesh in a first layer having a first clastic modulus in an axis in which a tension force is applied to the ITM, and (ii) a second section of the mesh in a second layer, which is placed in contact with the first layer and has in the axis, a second elastic modulus different from the first elastic modulus. The ITM is produced by integrating at least the outer layer and the stack of flexible support layers.

There is further provided, in accordance with an embodiment of the present invention, an intermediate transfer member (ITM) of a printing system, the ITM includes (a) a first outer layer, which is configured to receive droplets of a printing fluid for producing an image thereon, and to transfer the image to a target substrate, and (b) a second outer layer, which is configured to be placed in contact with an ITM module, the ITM module is configured for moving the ITM along an axis, the second outer layer including: (i) a flexible substrate, configured to conform with one or more components of the ITM module and to have a friction with at least one of the one or more components for moving the ITM along the axis, and (ii) one or more electrically conductive additives.

In some embodiments, the ITM includes a stack of flexible support layers, the stack including a mesh, having: (i) a first section impregnated in a first layer having a first clastic modulus in the axis in which a tension force is applied to the ITM, and (ii) a second section impregnated in a second layer, which is placed in contact with the first layer and has in the axis, a second clastic modulus different from the first elastic modulus, in response to applying to the ITM a specified level of the tension force, the stack of flexible support layers is configured to retain a predefined elongation of the ITM along the axis.

There is additionally provided, in accordance with an embodiment of the present invention, a system that includes an intermediate transfer member (ITM), and an image forming station. The ITM includes: (a) an outer layer, which is configured to receive droplets of a printing fluid for producing an image thereon, and to transfer the image to a target substrate, (b) a stack of flexible support layers, the stack including a mesh, having: (i) a first section impregnated in a first layer having a first elastic modulus in an axis in which a tension force is applied to the ITM, and (ii) a second section impregnated in a second layer, which is placed in contact with the first layer and has in the axis, a second elastic modulus different from the first clastic modulus. In response to applying to the ITM a specified level of the tension force, the stack of flexible support layers is configured to retain a predefined elongation of the ITM along the axis. The image forming station is configured to apply the droplets of the printing fluid to the ITM.

In some embodiments, the system includes an impression station, which is configured to engage between the ITM and the target substrate at an engagement point for transferring the image from the ITM to the target substrate.

There is further provided, in accordance with an embodiment of the present invention, a system including an intermediate transfer member (ITM) and an image forming station. The ITM includes (a) a first outer layer, which is configured to receive droplets of a printing fluid for producing an image thereon, and to transfer the image to a target substrate, and (b) a second outer layer, which is configured to be placed in contact with an ITM module, the ITM module is configured for moving the ITM along an axis, the second outer layer including: (i) a flexible substrate, configured to conform with one or more components of the ITM module and to have a friction with at least one of the one or more components for moving the ITM along the axis, and (ii) one or more electrically conductive additives. The image forming station is configured to apply the droplets of the printing fluid to the ITM.

There is additionally provided, in accordance with an embodiment of the present invention, an intermediate transfer member (ITM) of a printing system, the ITM includes: (a) an outer layer, which is configured to be placed in contact with an ITM module, the ITM module is configured for moving the ITM along an axis, the outer layer including: (i) a flexible substrate, configured to conform with one or more components of the ITM module and to have a friction with at least one of the one or more components for moving the ITM along the axis, and (ii) one or more electrically conductive additives, and (b) a stack of flexible support layers, the stack including a mesh, having: (i) a first section impregnated in a first layer having a first elastic modulus in an axis in which a tension force is applied to the ITM, and (ii) a second section impregnated in a second layer, which is placed in contact with the first layer and has in the axis, a second elastic modulus different from the first elastic modulus. In response to applying to the ITM a specified level of the tension force, the stack of flexible support layers is configured to retain a predefined elongation of the ITM along the axis.

There is additionally provided, in accordance with an embodiment of the present invention, a method for producing an intermediate transfer member (ITM) of a printing system, the method includes producing a first layer, which is an outer layer of the ITM for: (i) receiving droplets of a printing fluid and producing an image thereon, and (ii) transferring the image to a target substrate. A second layer is coupled to the first layer. The second layer includes a matrix holding particles at respective given locations, and in response to receiving optical radiation passing through the first layer, the particles heat the ITM by absorbing at least part of the optical radiation.

In some embodiments, the method includes producing the second layer by integrating the particles into the matrix, and arranging the particle within a bulk of the matrix at a predefined distance from one another and at a given distance from an interface between the first and second layers.

There is further provided, in accordance with an embodiment of the present invention, an intermediate transfer member (ITM) of a printing system, the ITM includes: (a) a first outer layer, which is configured to receive droplets of a printing fluid for producing an image thereon, and to transfer the image to a target substrate, (b) an inner layer, which is coupled to the first outer layer, the second layer including a matrix configured to hold particles at respective given locations, the second layer is configured to receive optical radiation passing through the first outer layer, and the particles are configured to heat the ITM by absorbing at least part of the optical radiation, and (c) a second outer layer, which is configured to be placed in contact with an ITM module, the ITM module is configured for moving the ITM along the axis, and the second outer layer includes: (i) a flexible substrate, configured to conform with one or more components of the ITM module and to have a predefined friction with at least one of the one or more components for moving the ITM along the axis, and (ii) one or more electrically conductive additives.

There is additionally provided, in accordance with an embodiment of the present invention, an intermediate transfer member (ITM) of a printing system, the ITM includes: (a) an inner layer, which is coupled to a first outer layer that receives droplets of a printing fluid for producing an image thereon, and transfers the image to a target substrate, the second layer including a matrix configured to hold particles at respective given locations, the second layer is configured to receive optical radiation passing through the first outer layer, and, the particles are configured to heat the ITM by absorbing at least part of the optical radiation, and (b) a second outer layer, which is configured to be placed in contact with an ITM module, the ITM module is configured for moving the ITM along the axis, the second outer layer including: (i) a flexible substrate, configured to conform with one or more components of the ITM module and to have a predefined friction with at least one of the one or more components for moving the ITM along the axis, and (ii) one or more electrically conductive additives.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIG. 2 is a schematic sectional view of a blanket of a digital printing system, in accordance with embodiments of the present invention;

FIG. 3 is a schematic sectional view of a process sequence for producing the blanket described in FIG. 2, in accordance with an embodiment of the present invention;

FIG. 4 is a flow chart that schematically illustrates a method for improving rigidity and electrical conductivity of the blanket described in FIG. 2, in accordance with an embodiment of the present invention;

FIG. 5 is a schematic sectional view of a blanket having a different structure than that of the blanket of FIG. 2 above, in accordance with another embodiment of the present invention;

FIG. 6 is a schematic sectional view of a process sequence for producing the blanket of FIG. 5, in accordance with an embodiment of the present invention; and

FIG. 7 is a flow chart that schematically illustrates a method for fabricating the blanket of FIG. 5, in accordance with an embodiment of the present invention.

### DETAILED DESCRIPTION OF EMBODIMENTS

### Overview

Some printing systems have an intermediate member, which is configured to receive an image from any suitable source and to transfer the image to a target substrate. In some cases, the intermediate member comprises a flexible member formed in an endless loop and having one or more panels that are intended to receive one or more of the images. The endless loop and the flexibility of the intermediate member are required in order to move the intermediate member in multiple revolutions, so that: (i) in each revolution, the one or more panels transfer the one or more images to a target substrate, and (ii) in the next revolution, the one or more panels are ready to receive the next image(s). The target substrate may comprise one or more sheets, a continuous web, or any other suitable substrate, and the intermediate member is moved using any suitable movement apparatus, such as motorized rollers.

Note that excess (i.e., higher than specified) elasticity of the intermediate member may result in one or more types of distortion, such as registration errors, in the printed images. Moreover, when the intermediate member is moved, the friction between the rollers and the intermediate member may produce undesired electrostatic charging in the intermediate member. The undesired charging may: (i) cause damage to components of the printing system (e.g., due to undesired electrical discharging that may occur between components of the system), and (ii) produce distortions in the printed images (e.g., due to undesired deflection of ink droplets that are jetted on the surface of the blanket).

Embodiments of the present invention that are described hereinafter provide efficient methods and systems for improving the rigidity and electrical conductivity of an intermediate transfer member (ITM) of a digital printing system.

In some embodiments, a digital printing system comprises a printing assembly having: (i) an image forming station configured to apply droplets of printing fluids (e.g., jetting ink droplets) to a surface of the ITM, also referred to herein as a blanket, for producing an image thereon, (ii) an impression station, configured to transfer the image from the blanket to a target substrate (e.g., a sheet), and (iii) a blanket module configured to move the blanket for (a) producing the image by receiving the ink droplets from the image forming station, and (b) transferring the image to the sheet. The digital printing system further comprises, a processor, which is configured to control the printing assembly.

In the present example, the blanket comprises a flexible member formed in an endless loop and having (a) multiple panels, each panel intended to receive an image, and (b) one or more sections that are not intended to receive an image. The blanket module is configured to rotate the blanket in multiple revolutions, and for each panel and each revolution, the processor controls the printing assembly to produce the image, and subsequently to transfer the image to the sheet, so that in the next revolution, each of the panels is ready to receive the next image.

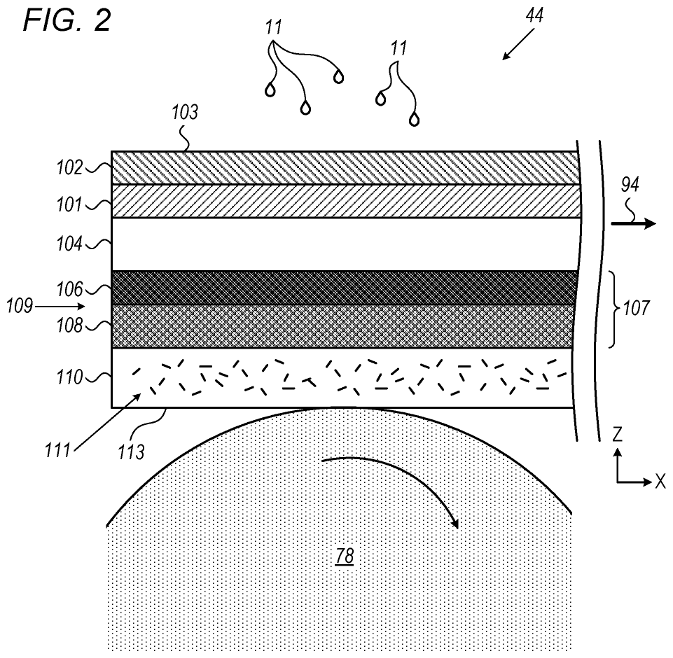

In some embodiments, the blanket comprises stacked layers, such as: (i) a release layer, (ii) one or more skeleton layer(s), (iii) a grip layer, and additional layers described in detail in FIGS. 2-3 and 5-6 below. Note that the release layer and the grip layer are positioned at a first and second respective external ends of the stacked layers of the blanket, and therefore, are also referred to herein as first and second external layers, respectively.

In some embodiments, the release layer comprises an ink reception surface, which is configured to receive the ink image, and to transfer the ink image to the target substrate. In some cases, the printing application may require at least partially drying the droplets of the printing fluid (e.g., ink) using optical radiation, such as but not limited to infrared (IR) radiation directed to the surface of the release layer. In some embodiments, the blanket comprises an infrared (IR) layer, which is coupled to the release layer and is substantially opaque to the IR radiation. The IR layer has a matrix comprising a suitable type of silicone, and carbon-black (CB) particles embedded within the matrix of the IR layer.

In some embodiments, the IR layer is configured to receive the IR radiation passing through the release layer, and, in response to the IR radiation, the CB particles are configured to heat at least the IR layer and the release layer of the ITM, so as to at least partially dry the ink droplets applied to the release layer.

In some embodiments, the CB particles are integrated into (e.g., implanted in) the silicone matrix and are arranged within the bulk of the matrix of the IR layer at a predefined distance from one another and at a given distance from the outer surface of the release layer. In such embodiments, because of the low thermal conductivity of the silicone matrix, the heat emitted from the CB particles is typically distributed uniformly within the IR layer and the release layer, and thereby, may at least partially dry the ink uniformly across the outer surface of the release layer.

In some embodiments, the grip layer has a high-friction surface, and is configured to make physical contact between the blanket and a blanket module having rollers and other components for moving the blanket in the revolutions described above. In some embodiments, the grip layer comprises a matrix made from: (i) a flexible material, such as silicone or any other suitable material(s), and (ii) electrically conductive additives, such as but not limited to carbon nanotubes (CNTs), which are embedded in the silicone matrix and are configured to improve the electrical conductivity of the grip layer.

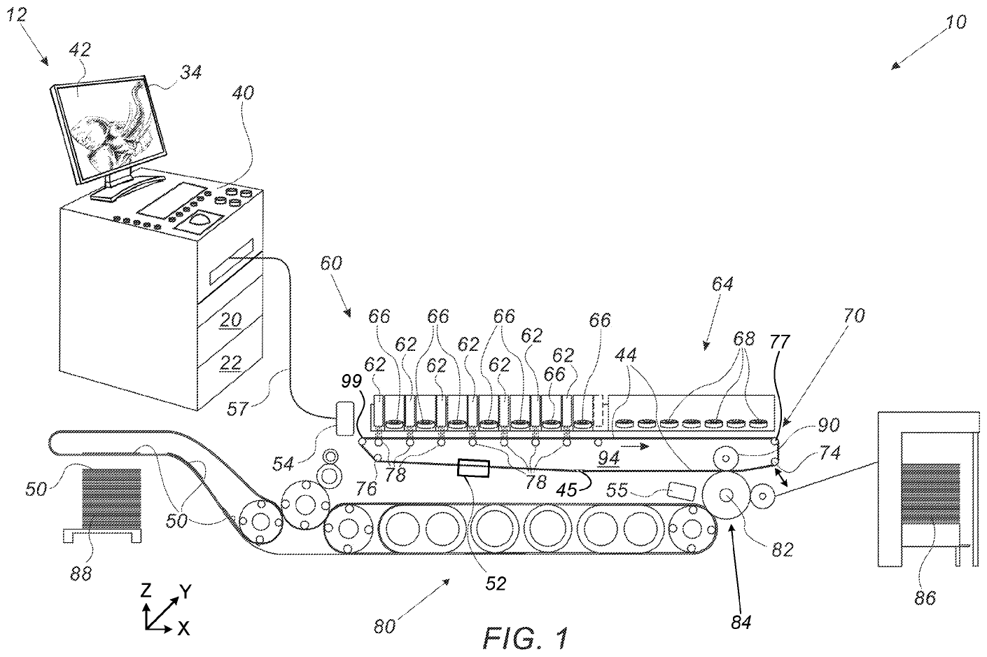

As described above, when the blanket is moved by the blanket module, the friction between the grip layer and components of the blanket module (e.g., the rollers and dancers described in FIG. 1 below), may cause unintentional and undesired electrostatic charging of the blanket. In some embodiments, the improved electrical conductivity of the grip layer, which is obtained by implementing the embedded CNT additives in the silicone matrix, reduces and typically eliminates the charging effect, and thereby, preventing damage to the printing system and distortion(s) in the printed images.

In some embodiments, the one or more skeleton layer(s) comprise a fiberglass fabric made from a woven mesh of glass fibers, which is impregnated in one or more materials, as described in detail in FIGS. 2-3 and 5-6 below. In one implementation, a first section of the fiberglass fabric is impregnated in an elastic layer, such as a silicone elastomer, (e.g., a vinyl-terminated polydimethylsiloxane (PDMS)), and a second section of the fiberglass fabric is impregnated in a layer that is more rigid than the silicone, such as an epoxy layer, which is positioned between the grip layer and silicone layers. In this implementation, (i) the silicone layer retains sufficient flexibility of the blanket, which is required for receiving and transferring the images, as described above, and (ii) the epoxy layer improves the rigidity (e.g., spring constant described in detail in FIG. 2 below) of the blanket, so as to control the stability of the specified dimensions of the moved blanket. Note that improving the stability of the blanket dimension, reduces the frequency of blanket replacement events, and therefore, improves the availability and output of the printing system. In another implementation, the fiberglass fabric that is made from a woven mesh of glass fibers, is impregnated in an clastic layer. For example, the mesh is impregnated in transparent silicone elastomer, such as PDMS. Note that in this implementation, the mesh is not impregnated in any sort of epoxy layer. In yet another implementation, the mesh may be impregnated solely in the epoxy layer, and is not impregnated in the PMDS.

The disclosed techniques improve: (i) the quality of images printed in a digital printing system having an intermediate transfer member, (ii) the productivity of such systems, and (iii) the cost associated with continuous printing of batches of images.

### System Description

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section also referred to herein as a seam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of blanket 44. In some embodiments, each print bar 62 comprises a strip of print heads as wide as the printing area on blanket 44 and comprises individually controllable printing nozzles configured to jet ink and other sort of printing fluids to blanket 44 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publications WO 2021/044303, and WO 2020/003088, whose disclosures are all incorporated herein by reference.

In some embodiments, blanket 44 is guided in blanket module 70 over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

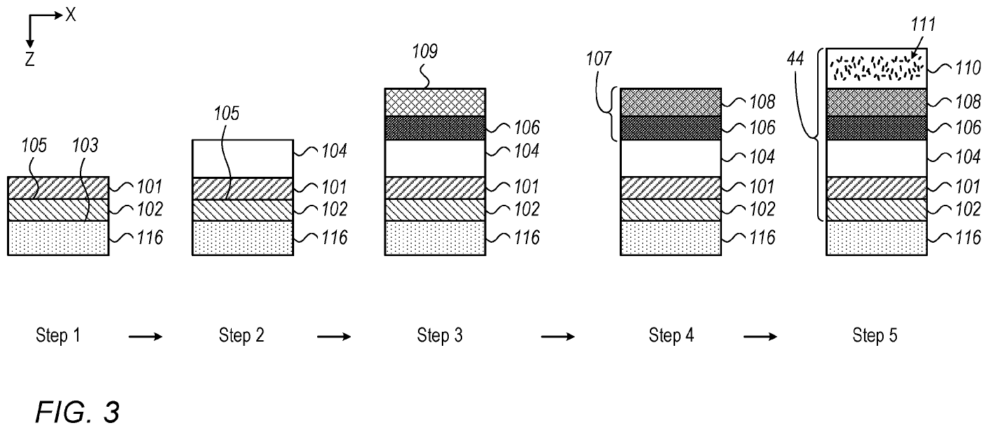

In impression station 84, blanket 44 passes between an impression cylinder 82 and a pressure cylinder 90, which is configured to carry a compressible blanket (shown in FIG. 3 below). In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may, additionally or alternatively, be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet, station 52 may be mounted adjacent to blanket 44 at any other or additional one or more suitable locations between impression station 84 and image forming station 60. As described above, station 52 may, additionally or alternatively, be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single and double sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

In some embodiments, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of threshold, and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Controlling Elasticity and Electrical Conductivity of the Blanket

The flexibility of blanket 44 is essential to carry out the image receiving and transferring as described in FIG. 1 above. Moreover, an elastic modulus (also known as modulus of elasticity) of blanket 44 typically determines the stiffness or flexibility of blanket 44, in response to a force (e.g., tension force) applied to blanket 44 in a given axis or in a given direction that is applied to blanket 44 in more than one axis.

In the present example, the elastic modulus is a constant that measures the resistance of blanket 44 to being deformed elastically (i.e., non-permanently) when a stress (e.g., a tension force) is applied to blanket 44 by system 10 (e.g., by blanket module 70). Note that the elastic modulus of a given element (e.g., blanket 44) may be different in different axes. For example, as shown in FIG. 1 above, the largest tension force is applied to blanket 44 in X-axis. Therefore, in some embodiments, blanket 44 is being configured to have the largest clastic modulus along the X-axis.

In some cases, uncontrolled deformation of blanket 44 may result in a distortion in the printed image. In one example, in case the deformation occurs in a section of blanket 44 while receiving the ink droplets (e.g., from print bars 62), the printed image may have a C2C registration error. In another example, in case the deformation occurs in a section of blanket 44 while transferring the image to a sheet 50, the printed image may have an image-to-substrate registration error.

The elastic modulus of blanket 44 is defined, in a test described herein, as the slope of its stress-strain curve in the elastic deformation region. Therefore, a stiffer blanket 44 may have a higher elastic modulus in one or more axes of interest.

In some embodiments, a different magnitude of tension force is applied, at the same time to different sections of blanket 44. The different magnitude of tension is used to retain different levels of tautness in the blanket being moved at different locations within system 10. For example, the tension force applied to blanket 44 (e.g., in direction 94) must be controlled: (i) very accurately when passing adjacent to image forming station 60 (in order to prevent C2C registration errors), and (ii) less accurately when passing between impression station 84 and blanket treatment station 52. Moreover, the different control level of the tension force may result in a cyclical stretching level of blanket 44 when being moved in different locations of system 10. Thus, blanket 44 demonstrated a spring behavior, and therefore, a measured spring constant of blanket 44 is indicative of the clastic modulus thereof.

In the context of the present disclosure and in the claims, the terms “rigid.” “hard” and “stiff” and grammatical variations thereof (e.g., rigidity, hardness, and stiffness) are used interchangeably and refer to the resistance of blanket 44 to being deformed elastically when the tension force is applied thereto.

In some embodiments, the inventors have developed a method for testing and measuring the spring constant of blanket 44 using a suitable testing product. In the present example, the inventors used a tension gauge product of the Lloyd material testing equipment family of products supplied by Ametek Inc. (Berwyn, Pennsylvania), or by any other suitable supplier.

In some embodiments, the testing procedure comprises applying about 20 cycles of a tension force between about 2 Newton (N) and 20 N (e.g., a gradually increased force, or a constant force) to a section having a width of about 20 mm and a length of about 150 mm that are measured, respectively, along the Y and X axes of the XYZ coordinate system shown in FIG. 1 above. The tension force was applied at a speed of about 20 mm/minute along the X-axis, Y-axis and at a diagonal direction of about 45° relative to the X and Y axes.

In some embodiments, the testing procedure and setup described above were applied to various configurations of blanket 44 that are described in FIG. 2 below. The spring constant of blanket 44, which is indicative of the blanket stiffness, was calculated in order to select the most suitable configuration of blanket 44 for each respective printing application carried out in system 44.

In some cases, when blanket 44 is being moved, the friction between blanket 44 and various components of system 10 (e.g., rollers 76 and 78, BCD 77, BTD 99, and dancer assembly 74), may cause undesired electrostatic charging of blanket 44. The undesired charge may be electrically discharged and cause damage to various components of system 10. For example, the accumulated charge may be conducted via the ink droplets landing on the blanket surface, toward a print bar 62 and may cause damage to one or more printing nozzles. Moreover, the electrical charge trapped in blanket 44 may cause undesired deflection of ink droplets that are jetted toward the surface of blanket 44. The deflection of one or more ink droplets from their intended locations to other locations, may produce a distortion in the images printed by system 10.

In the embodiments described in FIG. 2 below, several configurations of blanket 44 can be used for addressing the above-described uncontrolled deformation and charging problems of blanket 44.

FIG. 2 is a schematic sectional view of a blanket 44, in accordance with embodiments of the present invention. In the example of FIG. 2, a section of blanket 44 is moved in direction 94 between one print bar 62 (shown in FIG. 1 above) and one roller 78 rotating clockwise, whose section is shown in FIG. 2.

In some embodiments, blanket 44 comprises a release layer 102 having an ink reception surface 103, which is configured to: (i) receive droplets 11 of printing fluid(s) from print bar 62 for producing an image (also referred to herein as an ink image) thereon, and (ii) transfer the image to sheet 50. Note that release layer 102 that is an external layer of blanket 44, and particularly surface 103, are configured to have low release force to the ink image, measured by a wetting angle, also referred to herein as a receding contact angle (RCA), between surface 103 and the ink image.

In some embodiments, release layer 102 is made from a typically transparent silicone elastomer, such as a vinyl-terminated polydimethylsiloxane (PDMS), or from any other suitable type of a silicone polymer or another suitable material. In the present example, release layer may have a typical thickness between about 10 μm and 70 μm, or may have any other suitable thickness (e.g., larger than about 10 μm).

In some embodiments, blanket 44 comprises an infrared layer (IR) 101, which may be used in blanket 44 for printing applications that require infrared radiation applied to blanket 44 by drying station 64, as described in FIG. 1 above.

In some embodiments, IR layer 101 has an exemplary thickness between about 30 μm and 150 μm, and is configured to absorb the entire IR radiation of the IR beam emitted, for example, from drying station 64, or at least a significant portion thereof. For example, the confined IR layer 101 is adapted to absorb, within the top 5μ thereof, about 50% of the IR radiation of the IR beam. In other words, IR layer 101 is substantially opaque to the IR beam.

In some embodiments, IR layer 101 is applied to release layer 102 and has a surface interfacing therewith, and another surface interfacing with another layer 104 described in detail below.

In some embodiments, IR layer 101 comprises a matrix made from silicone (e.g., PDMS) and multiple particles disposed at given locations within the bulk of the PDMS matrix of IR layer 101. In some embodiments, the particles comprise a suitable type of pigment, such as but not limited to off-the-shelf carbon black (CB) particles, each of which having a typical diameter range between about 10 μm (for an IR layer having a thickness of about 30 μm) and 30 μm (for an IR layer having a thickness of about 50 μm).

In some embodiments, the particles are embedded at the bulk of IR layer 101, within a distance of about 10 μm or 20 μm from the aforementioned surface of the IR layer. The particles are also arranged uniformly along IR layer 101 at a distance of about 0.1 μm-5 μm from one another. In other embodiments, the distances to the surface and between the particles of IR layer 101 may be altered between different blankets, for example, at least one particle may be in close proximity or in contact with any of the surfaces of IR layer 101.

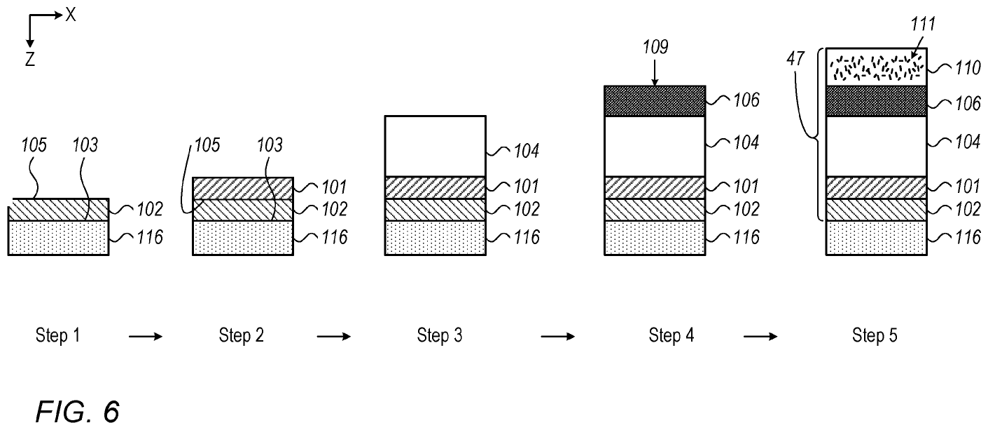

Additional embodiments related to IR layer 101 and other variations of IR layers, and the fabrication of blanket 44 having the IR layer as described above, are described in more detail in PCT International Publication WO 2021/105806, whose disclosure is incorporated herein by reference. Moreover, some embodiments related to the fabrication of blanket 44 have IR layer 101 are also described in FIGS. 5 and 6 below.

In some embodiments, blanket 44 comprises a conformal layer 104, also referred to herein as a compliance layer, typically made from PDMS with a black pigment additive. Conformal layer 104 is coupled to IR layer 101, or alternatively, to release layer 102 in case IR layer 101 is excluded from blanket 44. In such embodiments, conformal layer may have a typical thickness between about 50 μm and 400 μm, or any other suitable thickness.

In some embodiments, conformal layer 104 is configured to attenuate substantial intensity of light at selected wavelengths from being transmitted therethrough and/or from being reflected therefrom.

It will be understood that the level of attenuation depends on various parameters, such as layer thickness and wavelength of the light emitted by the sensing assembly. For example, UV wavelengths (e.g., about 10 nm-400 nm) may have larger attenuation compared to visible light (400 nm-700 nm) and infrared (IR) wavelengths (e.g., about 700 nm-1 mm).

In some embodiments, conformal layer 104 may have mechanical properties (e.g., greater resistance to tension) that differ from release layer 102. Such desired differences in properties may be obtained, e.g., by utilizing a different composition with respect to release layer 102, by varying the proportions between the ingredients used to prepare the formulation of release layer 102, and/or by the addition of further ingredients to such formulation, and/or by the selection of different curing conditions during the fabrication process of blanket 44. For example, implementing filler particles additives (not shown) in the PMDS of conformal layer 104, may increase the mechanical strength of conformal layer 104 relative to release layer 102.

In some embodiments, conformal layer 104 has hardness (and other elastic properties) that allow release layer 102 and surface 103 to conform with (i.e., follow closely) the surface contour of a substrate onto which an ink image is impressed (e.g., sheet 50).

In some embodiments, blanket 44 comprises reinforcement stacked layers, also referred to herein as a stack of flexible support layers 107 or a skeleton of blanket 44, which are coupled to conformal layer 104 and are described in detail below. In some embodiments, support layers 107 are configured to provide blanket 44 with the required flexibility in XYZ axes, and yet, with an improved mechanical resistance to deformation or tearing (mainly in X-axis, but also in Y-axis) that may be caused by the torque applied to blanket 44, e.g., by BCD 77, BTD 99, and dancer assembly 74.

In some embodiments, support layers 107 of blanket 44 comprise a mesh 109, which is made from a woven fiberglass fabric, or from any other suitable material(s), which is configured to be flexible in XYZ axes, and yet, with a larger mechanical resistance to deformation compared to that of the silicone-based layers of blanket 44, such as layers 102 and 104. The resistance to deformation, also referred to herein as rigidness or stiffness of the respective layer, is measured using the testing procedure described above, and has a metric referred to herein as the clastic modulus whose measurement and calculation are described above.

In some embodiments, mesh 109 of support layers 107 has a typical thickness (measured in Z-axis) between about 90 μm and 120 μm, and has first and second sections, which are impregnated with layers 106 and 108, respectively, and are described herein. Note that both layers 106 and 108 are formed together with the woven fiberglass fabric of mesh 109, and the impregnation of mesh 109 and other processes are described in detail in FIG. 3 below.

In some embodiments, layer 106, also referred to herein as an adhesion layer, is made from PDMS or any other suitable material, and has a typical thickness (measured in Z-axis) between about 20 μm and 50 μm, or any other suitable thickness.

In some embodiments, layer 108, is made from epoxy (e.g., C₂₁H₂₅ClO₅), also referred to herein as epoxy resin. In the present example, the epoxy resin is based on reaction products of bis-phenol A and epichlorohydrin, but in other embodiments, the epoxy resin may be based on any other suitable molecules known in the art, which are produced using any suitable reactions.

For example, layer 108 is made from a RESOLTECH HTGL 210 product and a Hardener HTGL 216 product with some additives, which is supplied by Resoltech (ROUSSET 13790, France), but may comprise any other suitable product supplied by any other suitable supplier. Note that layer 108 has an elastic modulus (e.g., in direction 94 or in X-axis) different from, and typically larger than, the elastic modules of layer 106 in the same axis and/or direction. In other words, layer 108 is more rigid (i.e., stiffer) that layer 106.

In other embodiments, layer 108 is made from or any other suitable substance or compound of elements, such as but not limited to: Poly Aryl Ether Ketone (PAEK), starch also referred to herein as Polysaccharides, polyimide, Polyethylene Terephthalate. In yet other embodiments, layer 108 is made from any suitable combination of two or more of the above-listed substances that may also comprise the aforementioned epoxy.

In some embodiments, layer 108 has a typical thickness (measured in Z-axis) of about 50 μm, or any other suitable thickness, such that a combination (i.e., the sum) of the thicknesses of layers 106 and 108 is approximately equal to the thickness of mesh 109. Note that layers 106 and 108 are typically placed in contact with one another. In some cases the adhesion between materials selected for layers 106 and 108 is not sufficiently-high for bonding between layers 106 and 108. In such embodiments, the reinforcement of mesh 109 retains layers 106 and 108 is contact with one another. In alternative embodiments, the materials selected for layers 106 and 108 may have sufficiently-high mutual adhesion, or a third section of mesh 109 may be impregnated in an additional suitable intermediate layer that may be used for bonding between layers 106 and 108.

In other embodiments, the sum of the thicknesses of layers 106 and 108 may differ from the thickness of mesh 109, for example, when an additional section of mesh 109 is impregnated in one or more additional layer(s). In yet other embodiments, mesh 109 may be impregnated only in a single layer, such as layer 108, which is stiffer than one or more of the silicone-based layers of blanket 44.

In alternative embodiments, layer 106, which is typically used for bonding between layers 108 and 104, may be removed from the configuration of blanket 44. In such embodiments, the section of mesh 109 that was impregnated in layer 106, may now be impregnated in at least a section of layer 104. In other words, a section of mesh 109 may be impregnated in a portion of layer 104.

In other embodiments, instead of stack 107, the blanket may comprise mesh 109 being fully impregnated in the PMDS (and/or any other suitable materials and/or variations of the PMDS described above) of layer 106. In other words, in this support layer, the entire size (along the Z-axis) of the woven fiberglass fabric of mesh 109, is impregnated in the PMDS, and does not have the epoxy or other substances of layer 108 as described above. In such embodiments, the typical thickness (measured along the Z-axis) of mesh 109 and layer 106 is between about 50 μm and 200 μm.

In some embodiments, the different configurations of the stack of flexible support layers 107 were tested using the testing procedures described above. Moreover, the different configurations were also characterized using additional types of testing. The various configurations are based on selected materials and thickness of the aforementioned layers, so as to obtain a set of different mechanical properties of blanket 44. For example, the spring constant calculated in the test performed using the Lloyd system is between about 20 and 50 when using only silicone-based (e.g., PMDS) layers in blanket 44, whereas when the same testing procedure is applied to blanket 44 having layer 108 made from epoxy (as shown in FIG. 2) or starch, the calculated spring constant is between about 70 and 120. In other words, the spring constant of blanket 44 is about 3-times higher when using epoxy or starch in layer 108.

In an embodiment, based on the characterization and the requirements of the printing application, a user of system 10 may select a suitable configuration of blanket 44 from among the above-described example configurations of blanket 44. Note that selecting the most suitable configuration, provides the user with improved quality of the printed images obtained by improving the stability of the blanket dimension. For example, an optimal rigidness of blanket 44 reduces the level of C2C registration errors (e.g., when applying droplets 11 to surface 103), and also reduces the level of image-to-substrate error(s) (e.g., during the image transfer process). Moreover, obtaining an optimal stiffness of blanket 44 may also reduce the frequency of blanket replacement events, and therefore, improves the availability, utilization and output of images printed in system 10 during a predefined time interval (e.g., 24 hours).

In some embodiments, blanket 44 comprises a high-friction layer, also referred to herein as a grip layer 110, made from a typically transparent PDMS and configured to make physical contact between blanket 44 and the components of system 10 configured for moving blanket 44 in direction 94. In the present example, a list of the parts in contact with blanket 44 comprises at least rollers 76 and 78, BCD 77, BTD 99, and dancer assembly 74 described in FIG. 1 above. Note that blanket 44 may also have contact with parts of blanket treatment station 52. For the sake of description clarity, one or more of the parts described above are also referred to herein as “components” or “transfer components” that are placed in contact with blanket 44.

In some embodiments, although grip layer 110 is made from relatively soft materials (e.g., PMDS), an outer surface of blanket 44, also referred to herein as a surface 113, which is facing the transfer components, has high friction so that blanket 44 can withstand the torque applied, e.g., by BCD 77, BTD 99 and rollers 78, without sliding.

In some embodiments, grip layer 110 may have a thickness between about 90 μm and 120 μm, but may alternatively have any other suitable thickness.

In some cases, the friction between blanket 44 and one or more of the transfer components may produce undesired electrostatic charging in grip layer 110. The electrical conductivity of the PMDS and other variations of the silicone-based and epoxy-based layers of blanket 44 may trap the produced charge within blanket 44. The charge carriers of the trapped electrostatic charge are typically moving to the outer layers of blanket 44, in the present example, to grip layer 110 and to release layer 102.

In some cases, the trapped electrostatic charge may be discharged, via droplets 11, to print bars 62, and in severe cases may cause damage to nozzles of the print bars. Moreover, the electrostatic charge trapped in release layer 102, may cause a deflection of one or more droplets 11, which may result in landing of the respective droplets 11, on surface 103, in position(s) that are different from the intended position(s) of the droplets on surface 103. More specifically, different types of printing fluids (e.g., different colors of ink) applied by image forming station 60 to surface 103, may have different susceptibilities to the trapped electrical charge. In such cases, a C2C registration error may occur in the image printed by system 11.

In some embodiments, grip layer 110 comprises one or more particles and/or nanotubes of an electrically conductive additive (ECA) 111. In some embodiments, the maximal size of the largest ECA 111 is smaller than about 10% of the thickness of grip layer 110. Moreover, ECAs 111 are typically arranged uniformly along grip layer 110 at a distance from one another, which is defined based on the type of ECA and the concentration level thereof, as will be described below.

In the present example, at least one ECA 111 comprises a carbon nanotube (CNT), such as a single-wall CNT (SWCNT) or a multi-wall CNT (MWCNT). The volume concentration of the CNTs in grip layer 110 is between about 0.1% and 20%.

In some embodiments, the majority (e.g., about 95% or more) of, and typically all ECAs 111 are positioned within the bulk of grip layer 110, so that both surface 113 and the interface between layers 110 and 108 remain uniform (i.e., without ECAs 111). In the context of the present disclosure and in the claims, the term “bulk” refers to about 80% of grip layer 110, which is located away from surface 113 and the interface between layers 108 and 110, at a distance about 10% of the thickness of grip layer 110. For example, in case the thickness of grip layer 110 is about 100 μm, most or all ECAs 111 are confined within a section of grip layer 110, which is positioned at a distance larger than about 10 μm from both surface 113 and the interface between layers 108 and 110.

In some embodiments, the SWCNT comprises a rolled layer of graphene having a typical diameter of about 1.3 nanometer, or any other suitable diameter, and the length of the SWCNT can be on an order of several thousands of nanometers. The SWCNTs have a single cylindrical wall and are typically capped at the end of the tube. In the present example, the SWCNTs comprise a master batch of SWCNT dispersed in Vinyl-terminated polydimethylsiloxane (PDMS), such as a TUBAII MATRIX 602 product, supplied by OCSIAL company (Leudelange, Luxembourg), but may comprise any other suitable product supplied by any other suitable supplier.

In some embodiments, the MWCNT comprises multiple rolled layers of graphene, typically arranged in concentric tubes. In the present example, the outer diameter of the MWCNT may have typical diameter size between about 2 nm and 1000 nm, depends on the number of walls of concentric tubes confined within the MWCNT. Typically, the distance between any pair of adjacent tubes of the MWCNT is between about 0.32 nm and 0.36 nm, which is substantially similar to the distance between graphene layers of a graphite.

In the present example, the MWCNTs comprise Multi-Walled Carbon Nanotube (MWCNT) in a vinyl-terminated DMS, such as a Silcosperse™ EC 106116 product, supplied by Avient Corporation (Avon Lake, OH, US), but may comprise any other suitable product supplied by any other suitable supplier.

In some embodiments, ECAs 111 may comprise any suitable combination of the SWCNTs and MWCNTs described above.

In other embodiments, at least one ECA 111 may comprise a particle made from carbon (e.g., black carbon, a nanoparticle (MP) in the form of C60), or a metal-based NP, such as a silver NP or a glass particle coated with metal (e.g., silver or another suitable metal). In yet other embodiments, at least one ECA 111 may comprise graphene or graphite. Note that the size of all ECAs 111 described above is typically smaller than about 1000 nm, or smaller than about 10% of the thickness of grip layer 110.

Additionally, or alternatively, ECAs 111 may comprise any suitable combination of the nanotubes and/or particles and/or nanoparticles described above, and/or any other suitable type of ECA 111.

In some embodiments, ECAs 111 are configured to improve the electrical conductivity of grip layer 110 and to discharge (i.e., by electrically conducting) the produced electrostatic charge away from blanket 44. In some embodiments, the inventors have developed a technique for testing the electrical conductivity of blanket 44. One example technique comprises measuring electrical resistance on surfaces 113 and/or 103 of blanket 44. In the present example, after moving blanket 44 in system 10 (for intentionally producing the electrostatic charge for the sake of testing and measuring), the measurement is carried out at temperatures between about 25° C. and 100° C., using a Fluke 1507 Insulation Resistance Tester, or a Fluke 179 Insulation Resistance Tester products, supplied by Fluke Corporation, (Everett, Washington), which is a wholly owned subsidiary of Fortive Corporation.

In some embodiments, the concentration of ECAs 111 is determined based on the specified electrical conductivity of blanket 44. Thus, ECAs 111 that have higher electrical conductivity compared to other sorts of ECAs 111 listed above, will be embedded in grip layer 110 at a lower volume concentration. For example, a SWCNT has high electrical conductivity compared to that of a silver particle. Therefore, the volume concentration of SWCNTs embedded within grip layer 110, can be smaller than that of silver particles. Note that the electrical conductivity of the CNTs is about 1000 higher compared to that of copper particles or silver particles.

In other cases, blanket 44 may be charged by charge carriers produced by any other undesired or unintended mechanism. In some embodiments, ECAs 111 are configured to conduct any sort of charge carriers that are trapped within blanket 44.

In some cases, the temperature of blanket 44 may increase above a specified allowed level. The temperature increase may occur due to the aforementioned friction and/or due to overheating of blanket 44, e.g., by drying station 64 during the drying process of the ink droplets applied to surface 103.

In some embodiments, ECAs 111 are configured to conduct excess heat produced in blanket 44, so that one or more of the transfer components (or any other suitable apparatus of system 10) may be used as a heat slug, for dissipating the excess heat, and thereby, for cooling blanket 44. More specifically, both types of the CNTs (SWCNT and MWCNT) of ECAs 111 have a thermal conductivity of about 8 times larger than the thermal conductivity of copper (which is considered one of the most thermally-conductive metal element. Thus, implementing the CNTs may improve the heat dissipation from blanket 44.

In some embodiments, both types of the CNTs (SWCNT and MWCNT) of ECAs 111 improve several properties of layer 110, and therefore, of blanket 44. For example, the weight of a CNT is about half of the weight of a metallic particle having the same size. Thus, the overall weight of blanket 44 is controllable and can be reduced.

In some embodiments, the tensile strength of a CNT is about 100 times larger than the tensile strength of a stainless steel or another metallic particle having the same size. Moreover, the clastic modulus of the CNTs is about 7 times larger than that of a stainless-steel particle. Thus, the tensile strength (and the clastic modulus) of blanket 44 can be controlled (e.g., increased) by implementing the CNTs in layer 110, and optionally in other suitable layers of blanket 44.

In some embodiments, implementing the CNTs in layer 110, and/or in one or more other suitable layers of blanket 44, may improve the chemical stability of blanket 44 and of various components of system 10. For example, the CNTs have a higher resistance to corrosion compared to that of the metallic particles described above. Thus, implementing the CNTs (rather than metallic particles) in layer 110, may increase the lifetime of blanket 44, and therefore, may increase the productivity (e.g., uptime, output) of system 10. Moreover, the increased lifetime of blanket 44 reduces the amount of waste associated with the operation of system 11, and therefore, make the use of system 11 more environmental-friendly.

Note that in the present example, blanket 44 has both (i) improved rigidity (obtained by implementing the stack of flexible support layers 107, and more specifically by layer 108 that is impregnated in mesh 109), and (ii) improved electrical conductivity (obtained by implementing ECAs 111 at least in layer 110). However, system 10 may operate with other blankets having only one of the above features, e.g., only improved rigidity, or only improved electrical conductivity, as described in embodiments described in the following two paragraphs.

In other embodiments, instead of blanket 44 system 10 may comprise a given blanket. The given blanket may comprise suitable ECAs 111 in one or more layers for obtaining improved electrical conductivity of the blanket. Moreover, the given blanket may not include any sort of rigid layer, such as layer 108 or any other sort of hardening layer. Instead, the given blanket may have only layers having high flexibility and low elastic modulus, such as silicone and PMDS. In such embodiments, the given blanket may have high electrical conductivity, but lower rigidity compared to blanket 44.

In yet other embodiments, instead of blanket 44 system 10 may comprise a different blanket. The different blanket may not have ECAs 111 or any other suitable mechanism for obtaining improve electrical conductivity, but may have the improved stiffness obtained by the stack of flexible support layers 107, and more specifically by layer 108 that is impregnated in mesh 109 as described above.

In alternative embodiments, IR layer 101, which is confined between layers 102 and 104 may be excluded from blanket 44, for example, in printing applications that do not require infrared radiation applied to blanket 44, e.g., by drying station 64.

The particular configuration of blanket 44 is shown by way of example, in order to illustrate certain problems, such as stretching and electrostatic charging) that are addressed by embodiments of the present invention and to demonstrate the application of these embodiments in enhancing the performance of such flexible intermediate transfer members. Embodiments of the present invention, however, are by no means limited to this specific sort of example blankets, and the principles described herein may similarly be applied to any other sorts of flexible intermediate transfer members used in any suitable sorts of printing systems.

FIG. 3 is a schematic sectional view of a process sequence for producing blanket 44 described in FIG. 2 above, in accordance with an embodiment of the present invention.

The process sequence begins at a step 1 with providing a carrier 116, which is used only for the fabrication process of blanket 44, and is removed after concluding the fabrication process. In the present example, the method for producing blanket 44 is carried out when the layers of blanket 44 are flipped (e.g., upside down) compared to the configuration shown in FIG. 2 above.

In some embodiments, carrier 116 may be formed of a flexible foil, such as a flexible foil comprising, aluminum, nickel, and/or chromium. In an embodiment, the foil comprises a sheet of aluminized polyethylene terephthalate (PET), also referred to herein as a polyester, e.g., PET coated with fumed aluminum metal.

In some embodiments, carrier 116 may be formed of an antistatic polymeric film, for example, a polyester film. The properties of the antistatic film may be obtained using various techniques, such as addition of various additives, e.g., an ammonium salt, to the polymeric composition.

In some embodiments, carrier 116 has a polished flat surface (not shown) having a roughness (Ra) on an order of about 50 nm or less, also referred to herein as a carrier contact surface.

In some embodiments, in step 1 a fluid first curable composition (not shown) is provided and a release layer 102 is formed therefrom on the carrier contact surface. In the present example, release layer 102 has a thickness between about 20 μm and 70 μm, as described in FIG. 2 above.

In some embodiments, release layer 102 comprises ink reception surface 103, which is configured to receive the ink image, and to transfer the ink image to sheet 50, as described in FIG. 1 above. Note that release layer 102, and particularly surface 103 are configured to have low release force to the ink image, measured by a wetting angle, also referred to herein as a receding contact angle (RCA), between surface 103 and the ink image, as described in FIG. 2 above.

In some embodiments, release layer 102 may be uniformly applied to PET-based carrier 116, leveled to a thickness between about 5 μm and 200 μm, and cured for approximately 2-10 minutes at 120-130° C. to obtain the aforementioned thickness (e.g., between about 20 μm and 70 μm) of release layer 102. Note that the hydrophobicity of ink transfer surface 103 may have an RCA of about 60°, with a 0.5-5 microliter (μl) droplet of distilled water. In some embodiments, a surface 105 of release layer 102 may have a RCA that is significantly higher, typically about 90°.

In some embodiments, PET carriers used to produce ink-transfer surface 103 may have a typical RCA of about 40° or less. All contact angle measurements were carried out using a Contact Angle analyzer “Easy Drop” FM40Mk2 produced by Krüss™ Gmbh, Borsteler Chaussee 85, 22453 Hamburg, Germany and/or using a Dataphysics OCA15 Pro, produced by Particle and Surface Sciences Pty. Ltd., Gosford, NSW, Australia.

In some embodiments, during step 1, IR layer 101 is formed over surface 105 of release layer 102. As described in FIG. 2 above, IR layer 101 comprises a matrix made from silicone (e.g., PDMS) and multiple particles (not shown) that are disposed at given locations within the bulk of the PDMS matrix of IR layer 101.

In alternative embodiments, blanket 44 may exclude IR layer 101, for example in in printing applications that do not require infrared radiation applied to blanket 44, e.g., by drying station 64. In such embodiments, step 1 may exclude the formation of IR layer 101, and the method may proceed by forming the next layer (which is described in step 2 below) directly over surface 105 of release layer 102.

At a step 2, conformal layer 104 is applied to the outer surface of IR layer 101. In the present example, conformal layer 104 has a thickness between about 50 μm and 400 μm, as described in FIG. 2 above. In some embodiments, the attachment of conformal layer 104 to the outer surface of IR layer 101 may require the application of a suitable adhesive or bonding composition in addition to the material of conformal layer 104.

In alternative embodiments, IR layer 101 is excluded from the structure of blanket 44, and therefore, conformal layer 104 is applied directly to surface 105 of release layer 102. In such embodiments, the attachment of conformal layer 104 to surface 105 may require the application of a suitable adhesive or bonding composition in addition to the material of conformal layer 104.

At a step 3, a first section of mesh 109 is impregnated in adhesion layer 106, and the impregnated fiberglass fabric of mesh 109 is applied to conformal layer 104. In some embodiments, the thickness of adhesion layer is between about 20 μm and 50 μm, and the thickness of mesh 109 is between about 90 μm and 120 μm, as described in FIG. 2 above.

At a step 4, a second section of mesh 109 is impregnated in layer 108 made from epoxy or starch or any other suitable substance or combination of substances described in detail in FIG. 2 above. Note that layer 108 has an elastic modulus (e.g., in direction 94 or in X-axis) larger than (or different from) the elastic modules of layer 106, and has a thickness of about 50 μm, as described in FIG. 2 above.

In some embodiments, steps 3 and 4 conclude the fabrication of the stack of flexible support layers 107.

In other embodiments, the fabrication of flexible support layers 107 may be carried out using any other suitable sequence. For example, the impregnation of the fiberglass fabric of mesh 109 may be carried out in a separate process, and subsequently, the entire stack of flexible support layers 107 (i.e., mesh 109 impregnated in layers 106 and 108) may be coupled to conformal layer 104.

In yet other embodiments, the impregnation of the fiberglass fabric of mesh 109 may be carried out in a separate process, and subsequently, conformal layer 104 may be coupled to the finished stack of flexible support layers 107. In such embodiments, release layer 102 and carrier 116 may be coupled to conformal layer 104.

In alternative embodiments, instead of support layers 107, blanket 44 may have any suitable type of a different structure, such as having mesh 109: (i) fully impregnated only in 108 epoxy layer 108, or (ii) fully impregnated only in the PMDS of adhesion layer 106 (as will be described in detail in FIGS. 5 and 6 below). Note that in case mesh 109 is fully impregnated only in the PMDS of adhesion layer 106, the process of step 3 above comprises full impregnation of mesh 109 in the PMDS of adhesion layer 106, and step 4 may be eliminated from the process sequence of FIG. 3. In other words, step 4 may be optional.

Additionally, or alternatively, instead of support layers 107, blanket 44 may have any other suitable structure comprising any suitable combination of selected layers.

At a step 5 that concludes the production method of the stacked layer of blanket 44, grip layer 110 that comprises one or more particles and/or nanotubes of electrically conductive additives (ECAs) 111 is applied to layer 108 of support layers 107. In the present example, grip layer 110 has a thickness between about 90 μm and 120 μm, as described in FIG. 2 above.

In some embodiments, step 5 comprises the implementation or disposing of ECAs 111 in the bulk of grip layer 110, and subsequently, grip layer 110 is applied to layer 108.

In other embodiments, the PMDS matrix of grip layer 110 is applied to layer 108, and subsequently, ECAs 111 are disposed within the bulk of grip layer 110.

In both embodiments, ECAs 111 must be disposed uniformly within the bulk of grip layer 110 in order to obtain uniform electrical conductivity (and thermal conductivity) along grip layer 110. Note that as long as the dispersion of the MWCNT in the uncured silicone is homogeneous and stable, the coated layer is sufficiently homogeneous.

In some embodiments, layers 108 is made from epoxy and layer 110 is made from PMDS or from another form of silicone. Epoxy and PMDS may have low adhesion force therebetween, thus, layers 108 and 110 may be coupled using a coupling agent. In some embodiments, the coupling agent comprises a bonding layer (not shown) that may be applied between layers 108 and 110. In other embodiments, a coupling agent may be added to layer 110, however, a coupling agent may be applied also as adhesion promoter on the epoxy layer. In alternative embodiments, a third section (not shown) of mesh 109 (that is not impregnated with layer 106 or 108 and is positioned between layers 108 and 110), may be impregnated with at least a portion of grip layer 110, so as to obtain sufficiently strong coupling between layers 108 and 110.

In some embodiments, after concluding step 5, carrier 116 is removed from the stacked layers shown in step 5, so that the production of blanket 44 is completed.

Additional embodiments related to one or more layers of blanket 44, and manufacturing techniques of at least some of the stacked layers of blanket 44, are described in detail in PCT application PCT/IB2019/055288 and in PCT international publication WO 2017/208144, whose disclosures are incorporated herein by reference.

The particular sequence of steps 1-5 of FIG. 3 is shown by way of example. Embodiments of the present invention, however, are by no means limited to this specific sequence of steps that are simplified for the sake of conceptual clarity. Moreover, the principles described herein may similarly be applied to any other sorts of process flow used for producing blanket 44 or any other suitable type of ITM having any suitable configuration of layers, which may have any suitable thickness and are made from any suitable materials that are different from the example configuration of blanket 44 described in FIG. 2, and of the process flow for producing blanket 44 as described in FIG. 3 above.

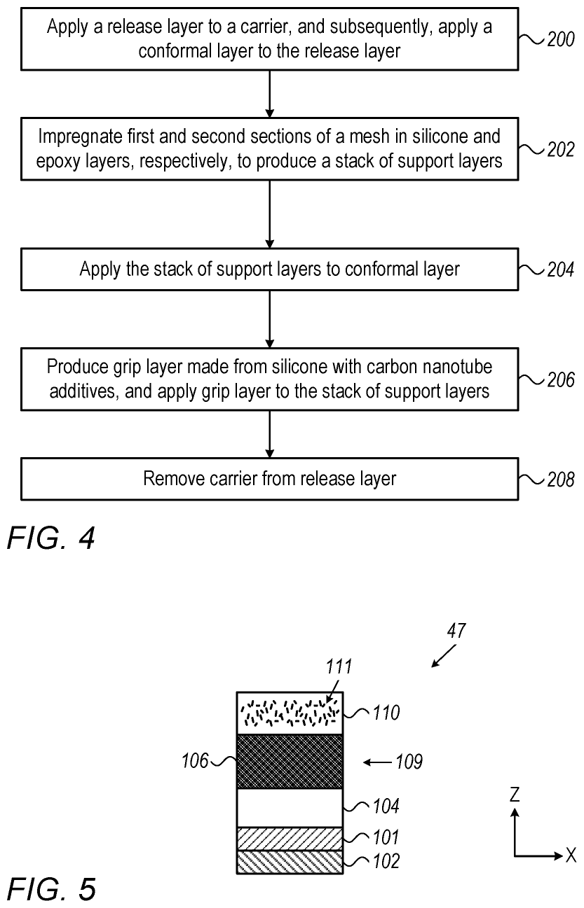

FIG. 4 is a flow chart that schematically illustrates a method for improving the rigidity and electrical conductivity of blanket 44, in accordance with an embodiment of the present invention.

The method begins at a release and conformal layers production step 200 with applying release layer 102 to carrier 116, as described in detail in step 1 of FIG. 3 above, and subsequently, apply conformal layer 104 to release layer 102, as described in detail in step 2 of FIG. 3 above.

At a support layers production step 202, first and second sections of mesh 109 are impregnated in silicone-based layer 106 and in epoxy-based layer 108, respectively, so as to produce stack of support layers 107. At a support layers integration step 204, the stack of support layers 107 is applied to conformal layer 104. Note that in steps 202 and 204, the entire stack of support layers 107 is produced, and is subsequently applied to conformal layer 104.

In other embodiments, steps 202 and 204 may be replaced with another 2-step process, such as: (i) mesh 109 (whose first section is already impregnated in adhesion layer 106) is applied to conformal layer 104, and subsequently, (ii) a second section of mesh 109 is impregnated in layer 108, as described in several embodiments of steps 3 and 4 of FIG. 3 above.

In alternative embodiments, steps 202 and 204 may be replaced with a 3-step process, such as: (i) mesh 109 is applied to conformal layer 104, thereafter (ii) the first section of mesh 109 is impregnated in layer 106, and subsequently, (iii) the second section of mesh 109 is impregnated in layer 108.

At a grip layer production step 206, grip layer 110, which is made from silicone (e.g., PMDS) and as ECAs 111, such as CNT additives that are described in detail in FIG. 2 above, is produced and applied to stack of support layers 107 as described in step 5 of FIG. 3 above. In other embodiments, grip layer 110 of blanket 44 may be produced without ECAs 111, so that grip layer 110 may comprise PMDS that may not have any additives, or may have additives that are not related to altering (e.g., improving) the electrical conductivity of blanket 44.

In alternative embodiments, instead of the additives described above, layer 110 may comprise any other sort of composite material having a combination of two materials with different physical and/or chemical properties. For example, a matrix made from any suitable type of silicone (e.g., PMDS), and one or more fibers disposed within the bulk of the PMDS. The fibers may be arranged in a (1D) one-dimensional array (e.g., having their longitudinal axis parallel to X-axis or at any other suitable orientation relative to X-axis, or parallel to Y-axis), or in a two-dimensional (2D) array of fibers (that may or may not be woven). The array of fibers may be disposed at any suitable orientation relative to the X, Y and Z axes shown in FIG. 1 above. Additionally, or alternatively, blanket 44 may comprise an electrically conductive layer disposed within the bulk of grip layer 110 and/or between any two layers of blanket 44, such as between grip layer 110 and layer 108, or at any other position within blanket 44.

At a carrier removal step 208 that concludes the method, carrier 116 is removed from release layer 102, and the production of blanket 44 is completed.

In other embodiments, blanket 44 may comprise, instead of stack of support layers 107, a different stack of support layers, such as but not limited to mesh 109 impregnated in one or more of layers 104, 106, 108 and 110. In such embodiments, one or more of layers 104, 106 and 108 may be removed from the configuration of blanket 44.

FIG. 5 is a schematic sectional view of a blanket 47, in accordance with another embodiment of the present invention. Blanket 47 may replace blanket 44 in FIG. 1 above.

With reference to blanket 44 of FIG. 2 above, in some embodiments, instead of stack 107, blanket 47 comprises mesh 109 (shown in FIG. 2 above) being fully impregnated in the PMDS (and/or any other suitable materials and/or variations of the PMDS described above) of layer 106. In other words, in this support layer, the entire size (along the Z-axis) of the woven fiberglass fabric of mesh 109, is impregnated in the PMDS of layer 106, and does not have the epoxy or other substances of layer 108 as shown in FIGS. 2 and 3 above. In such embodiments, the typical thickness (measured along the Z-axis) of mesh 109 and layer 106 is between about 50 μm and 200 μm.

In some embodiments, layers 101, 102, 104, and 110 of blankets 44 and 47 are approximately similar, i.e., have approximately the same thickness and substances to the corresponding layers 101, 102, 104, and 110 described in detail in FIGS. 2 and 3 above.

In other embodiments, blanket 47 may exclude at least one of layers 101, 102, 104, and 110, or may have any suitable variance in one or more of these layers.

FIG. 6 is a schematic sectional view of a process sequence for producing blanket 47, in accordance with an embodiment of the present invention.

The process sequence begins at a step 1 with providing carrier 116, and subsequently, forming release layer 102 over surface 103 of release layer 102, as described in detail in FIG. 3 above. At a step 2, IR layer 101 is formed over surface 105 of release layer 102, as also described in step 1 of FIG. 3 above.

At a step 3, conformal layer 104 is applied to the outer surface of IR layer 101, e.g., using the process described in detail in step 2 of FIG. 3 above.

At a step 4, mesh 109 is fully impregnated in the PMDS of layer 106, and the combination of mesh 109 and layer 106 is disposed over the outer surface of conformal layer 104.

At a step 5 that concludes the production method of the stacked layer of blanket 47, grip layer 110 that comprises one or more particles and/or nanotubes of electrically conductive additives (ECAs) 111 is applied to layer 106 (which is impregnating mesh 109). In the present example, grip layer 110 has a thickness between about 90 μm and 120 μm, as described in detail in FIGS. 2 and 3 above.

In some embodiments, after concluding step 5, carrier 116 is being disjointed from layer 102, and thereby, removed from the stacked layers shown in step 5, so that the production of blanket 47 is completed.

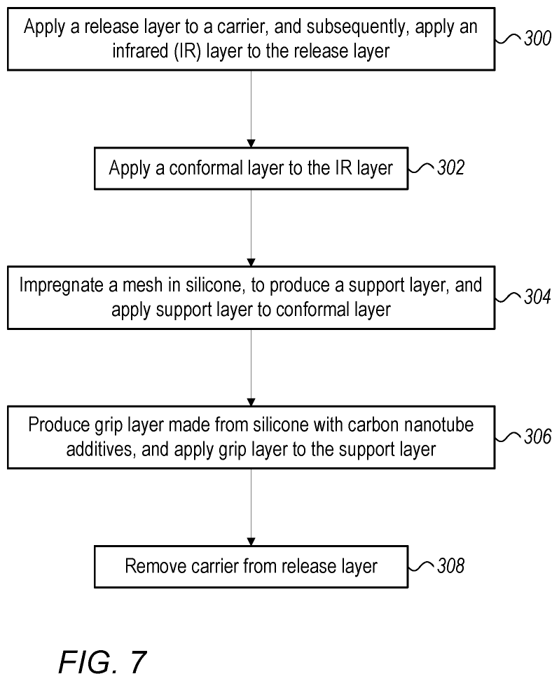

FIG. 7 is a flow chart that schematically illustrates a method for fabricating blanket 47, which is described in FIGS. 5 and 6, and has improved rigidity and electrical conductivity, in accordance with an embodiment of the present invention.

The method begins at a release and IR layers production step 300 with applying release layer 102 to carrier 116, as described in detail in step 1 of FIG. 6 above, and subsequently, applying IR layer 101 to the outer surface of release layer 102, as described in detail in step 2 of FIG. 6 above.

At a conformal layer production step 302, conformal layer 104 is applied to the outer surface of IR layer 101, as described in detail in step 3 of FIG. 6 above.

At a support layer production step 304, mesh 109 is impregnated in silicone-based layer 106, so as to produce the support layer, which is a combination of mesh 109 and layer 106. Subsequently, the support layer is applied to the outer surface of conformal layer 104, as described in FIG. 6 above.

At a grip layer production step 306, grip layer 110, which is made from silicone (e.g., PMDS) and as ECAs 111, such as CNT additives that are described in detail in FIG. 2 above, is produced and applied to the support layer (made from mesh 109 impregnated in the PMDS of layer 106) as described in more detail in step 5 of both FIGS. 3 and 6 above.

In other embodiments, grip layer 110 of blanket 47 may be produced without ECAs 111, so that grip layer 110 may comprise PMDS that may not have any additives, or may have additives that are not related to altering (e.g., improving) the electrical conductivity of blanket 47.

In alternative embodiments, instead of the additives described above, layer 110 may comprise any other sort of composite material having a combination of two materials with different physical and/or chemical properties. For example, a matrix made from any suitable type of silicone (e.g., PMDS), and one or more fibers disposed within the bulk of the PMDS. The fibers may be arranged in a (1D) one-dimensional array (e.g., having their longitudinal axis parallel to X-axis or at any other suitable orientation relative to X-axis, or parallel to Y-axis), or in a two-dimensional (2D) array of fibers (that may or may not be woven). The array of fibers may be disposed at any suitable orientation relative to the X, Y and Z axes shown in FIG. 1 above. Additionally, or alternatively, blanket 47 may comprise an electrically conductive layer disposed within the bulk of grip layer 110 and/or between any two layers of blanket 47, such as between grip layer 110 and layer 106, or at any other position within blanket 47.

At a carrier removal step 308 that concludes the method, carrier 116 is removed from release layer 102, and the production of blanket 47 is completed.

Although the embodiments described herein mainly address digital printing using a flexible intermediate transfer member, the methods and systems described herein can also be used in other applications, such as in any sort of printing system and process having any suitable type of an intermediate apparatus (e.g., member) for receiving an image and transferring the image to a target substrate.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An intermediate transfer member (ITM) of a printing system, the ITM comprising:
an outer layer, which is configured to receive droplets of a printing fluid for producing an image thereon, and to transfer the image to a target substrate; and
a stack of flexible support layers, the stack comprising a mesh, having: (i) a first section impregnated in a first layer having a first elastic modulus in an axis in which a tension force is applied to the ITM, and (ii) a second section impregnated in a second layer, which is placed in contact with the first layer and has in the axis, a second elastic modulus different from the first elastic modulus,
wherein, in response to applying to the ITM a specified level of the tension force, the stack of flexible support layers is configured to retain a predefined elongation of the ITM along the axis.

2. The ITM according to claim 1, wherein the mesh comprises a woven fiberglass fabric.

3. The ITM according to claim 1, wherein the second layer comprises a substance selected from a list of substances consisting of: (i) epoxy, (ii) Poly Aryl Ether Ketone (PAEK), (iii) Polysaccharides, (iv) polyimide, Polyethylene Terephthalate, and (v) a combination of two or more of the substances of the list.

4. The ITM according to claim 1, and comprising an additional outer layer, which is configured to be placed in contact with an ITM module, wherein the ITM module is configured for moving the ITM along the axis, the additional outer layer comprising: (i) a flexible substrate, configured to conform with one or more components of the ITM module and to have a friction with at least one of the one or more components for moving the ITM along the axis, and (ii) one or more electrically conductive additives.

5. The ITM according to claim 4, wherein the one or more electrically conductive additives are configured to discharge an electrostatic charge away from the flexible substrate.

6. The ITM according to claim 4, wherein the electrically conductive additives comprise one or more additives selected from a list of additives consisting of: (i) one or more nanotubes (NTs), (ii) one or more particles, and (iii) a combination of the one or more NTs and particles.

7. The ITM according to claim 6, wherein the NTs comprise carbon nanotube (CNTs) selected from a list of CNTs consisting of: (i) a multi-wall CNT (MWCNT), (II) a single-wall CNT (SWCNT), and (iii) a combination of one or more MWCNTs and SWCNTs.

8. The ITM according to claim 7, wherein the additional outer layer comprises one of: (i) a first volume concentration of the MWCNT, (ii) a second volume concentration of the SWCNT, which is smaller than the first volume concentration, and (iii) a combination of the MWCNT and SWCNT having a third volume concentration that is smaller than the first volume concentration and larger than the second volume concentration, so as to obtain a predefined electrical conductivity of the additional outer layer.

9. The ITM according to claim 7, wherein the CNTs are configured to alter one or both of: (i) a third elastic modulus of the additional outer layer, and (ii) a thermal conductivity of the additional outer layer.

10. The ITM according to claim 7, wherein the one or more particles are selected from a list of particles consisting of: (i) metallic nanoparticle (NPs), (ii) carbon-based NPs, (iii) glass particles coated with metal, (iv) graphene particles, (v) graphite particles, and (vi) a combination of two or more of the particles selected from the list of particles.

11. A method for producing an intermediate transfer member (ITM) of a printing system, the method comprising:
producing an outer layer for: (i) receiving droplets of a printing fluid and producing an image thereon, and (ii) transferring the image to a target substrate;
producing a stack of flexible support layers by impregnating (i) a first section of a mesh in a first layer having a first elastic modulus in an axis in which a tension force is applied to the ITM, and (ii) a second section of the mesh in a second layer, which is placed in contact with the first layer and has in the axis, a second elastic modulus different from the first elastic modulus; and
producing the ITM by integrating at least the outer layer and the stack of flexible support layers.

12. The method according to claim 11, wherein producing the stack comprises using the mesh comprising a woven fiberglass fabric.

13. The method according to claim 11, wherein producing the stack comprises using the second layer that comprises a substance selected from a list of substances consisting of: (i) epoxy, (ii) Poly Aryl Ether Ketone (PAEK), (iii) Polysaccharides, (iv) polyimide, Polyethylene Terephthalate, and (v) a combination of two or more of the substances of the list.

14. The method according to claim 11, and comprising producing an additional outer layer, which is placed in contact with an ITM module that moves the ITM along the axis, wherein producing the additional outer layer comprising: (i) receiving a flexible substrate, that conforms with one or more components of the ITM module and has a friction with at least one of the one or more components for moving the ITM along the axis, and (ii) disposing one or more electrically conductive additives in the flexible substrate.

15. The method according to claim 14, wherein the one or more electrically conductive additives are for discharging an electrostatic charge away from the flexible substrate.

16. The method according to claim 14, wherein disposing the electrically conductive additives comprise disposing one or more additives selected from a list of additives consisting of: (i) one or more nanotubes (NTs), (ii) one or more particles, and (iii) a combination of the one or more NTs and particles.

17. The method according to claim 16, wherein the NTs comprise carbon nanotube (CNTs) selected from a list of CNTs consisting of: (i) a multi-wall CNT (MWCNT), (II) a single-wall CNT (SWCNT), and (iii) a combination of one or more MWCNTs and SWCNTs.

18. The method according to claim 17, and comprising, applying to the additional outer layer one of: (i) a first volume concentration of the MWCNT, (ii) a second volume concentration of the SWCNT, which is smaller than the first volume concentration, and (iii) a combination of the MWCNT and SWCNT having a third volume concentration, for obtaining a predefined electrical conductivity of the additional outer layer.

19. The method according to claim 16, wherein applying the CNTs comprises altering one or both of: (i) a third elastic modulus of the additional outer layer, and (ii) a thermal conductivity of the additional outer layer.

20. The method according to claim 16, wherein disposing the one or more particles comprises selecting the one or more particles from a list of particles consisting of: (i) metallic nanoparticle (NPs), (ii) carbon-based NPs, (iii) glass particles coated with metal, (iv) graphene particles, (v) graphite particles, and (vi) a combination of two or more of the particles selected from the list of particles.

21-46. (canceled)
